(19) United States
(12) Patent Application Publication
(10) Pub. No.: US 2023/0161039 A1
(43) Pub. Date: May 25, 2023

(54) POSITION MEASURING SYSTEM, POSITION MEASURING DEVICE, AND POSITION MEASURING METHOD

(71) Applicant: NIPPON TELEGRAPH AND TELEPHONE CORPORATION, Tokyo (JP)

(72) Inventors: Atsuko KAWAKITA, Musashino-shi, Tokyo (JP); Tomohiro TANIGUCHI, Musashino-shi, Tokyo (JP); Kazutaka HARA, Musashino-shi, Tokyo (JP)

(73) Assignee: NIPPON TELEGRAPH AND TELEPHONE CORPORATION, Tokyo (JP)

(21) Appl. No.: 17/922,778

(22) PCT Filed: Jul. 20, 2020
(86) PCT No.: PCT/JP2020/028052

§ 371 Date: Nov. 1, 2022

(30) Foreign Application Priority Data
May 13, 2020 (JP) PCT/JP2020/019070

(51) Int. Cl. G01S 17/42; G01S 7/481

(52) U.S. Cl. CPC G01S 17/42; G01S 7/4818

(57) ABSTRACT

It is an object of the present invention to provide a position measuring system, a position measuring device, and a method for measuring a position that can accurately measure the position of an object to be measured without being limited by an environment or an optical axis.

A position measuring device 20 according to the present invention is characterized by including a light receiving unit 21 configured to receive scattered light Lsc emitted from a side surface of an optical fiber 50, a database 22 configured to store a correspondence between information on the scattered light and a position of the object to be measured, and a determination unit 23 configured to determine, based on the correspondence stored in the database, a position of the object to be measured from information on the scattered light received by the light receiving unit.

### TECHNICAL FIELD

The present disclosure relates to a position measuring system, a position measuring device, and a method for measuring a position that measure the position of an object.

### BACKGROUND ART

An example of a typical method used for measuring the position of an object includes a distance measurement method that uses satellites or light. As the most typical technique for satellite distance measurement, there is the global positioning system (hereinafter referred to as “GPS”). The GPS is a system where signals from a plurality of GPS satellites in the sky are received by a GPS receiver, and a simultaneous equation based on three-point positioning is solved from three or more pieces of information from the satellites, such as “time” or “position”, to allow a receiver to know the current position of the receiver. It is said that the GPS has a measurement accuracy of approximately several meters due to atmospheric delay, the effect of multipathing caused by the environment, and the effect of the number of satellites in arrangement (the number of captured satellites).

In contrast, an example of a typical technique for distance measurement that uses light includes LiDAR (light detection and ranging). In LiDAR, the distance from an object to be measured is measured based on the time of flight (hereinafter referred to as “ToF”) of light that propagates through the space by making use of a light receiver and a light source having high coherence, such as a laser light source. It is said that LiDAR has a measurement accuracy of approximately several centimeters due to the effect of modulated pulse repetition period, pulse width, and shot noise from background light other than light from the light source.

### CITATION LIST

### Patent Literature

Patent Literature 1: Japanese Patent No. 6187500
Patent Literature 2: Japanese Translation of PCT International Application Publication No. 2016-526148

### SUMMARY OF THE INVENTION

### Technical Problem

The above-mentioned two distance measurement techniques have a problem in that there is a limitation on the use of each technique depending on the measurement environment.

For example, when an indoor environment exposed to electromagnetic noise, such as a factory, is considered, distance measurement by a GPS cannot be used due to reduction in measurement accuracy and electromagnetic interference caused with indoor use. In comparison, in the case of LiDAR, light wave interference from a device that makes use of other light is considered. However, light has a higher rectilinearity compared with radio waves and hence, LiDAR is less affected by electromagnetic noise even in an environment exposed to the electromagnetic noise, therefore distance measurement can be performed.

However, when position measurement (distance measurement) is performed by LiDAR in an environment in a factory shown in FIG. 1, measurement accuracy is reduced and hence, it becomes difficult to obtain an accurate position of an object to be measured. For example, in the case where it is necessary to perform position measurement (distance measurement) to monitor and control an object to be measured (a robot, for example) shown in FIG. 1, a method that makes use of a two dimensional LiDAR can be considered. In the environment, such as in a factory, it is anticipated that various devices and workers are present in the movement range of the object to be measured. When a blocking object that blocks light is present in a space and with respect to the object to be measured (on an optical axis), it becomes difficult for LiDAR to accurately perform distance measurement.

To cope with the above-mentioned reduction in measurement accuracy of LiDAR, the following measures can be considered:

(1) the position where LiDAR is installed is designed by taking into account the driving range of the object to be measured;

(2) a plurality of LiDARs are used and results from the plurality of LiDARs are processed; and

(3) as described in Patent Literature 1, safety fences are provided on both sides of a motion trajectory of the object to be measured, and landmarks for self-position estimation are attached to the safety fences.

However, to take such measures, it is necessary to take into account the motion range of the object to be measured and hence, a limitation is imposed on the design of a factory. Further, the number of LiDARs installed increases, and it is necessary to install planar safety fences and landmarks for self-position estimation and hence, cost increases.

When an attempt is made to perform position measurement in water, the following problems occur in the same manner:

(1) radio waves significantly attenuate in water and hence, the GPS cannot be used; and

(2) in the case of LiDAR, as described in Patent Literature 2, for example, there is a system that inspects an undersea structure or an underwater structure by using autonomous underwater equipment provided with a three dimensional LiDAR. However, measurement of an object to be measured is limited only on the optical axis of LiDAR and hence, LiDAR is required to have a steering function of changing the direction of the optical axis of LiDAR toward the position of the undersea structure or the underwater structure whereby cost increases. Further, when a blocking object that blocks light is present in a space (water) and with respect to the object to be measured, it is difficult to accurately perform position measurement.

That is, in measuring the position of an object, there are the following problems: it is difficult for the GPS to measure the position of the object in an environment exposed to electromagnetic noise, such as in a factory, or in water where radio waves are significantly attenuated. In the case of LiDAR, the cost to install LiDAR increases when the relationship between the position of the object and the optical axis is taken into consideration.

In view of the above, to solve the above-mentioned problems, it is an object of the present invention to provide a position measuring system, a position measuring device, and a method for measuring a position that can accurately measure the position of an object to be measured without being limited by an environment or an optical axis.

### Means for Solving the Problem

To achieve the above-mentioned object, in a position measuring system according to the present invention, a position measuring device installed to an object to be measured receives scattered light emitted from a side surface of an optical fiber installed along a trajectory of the object to be measured, and a position of the object to be measured is estimated based on intensity or color information of the scattered light received.

Specifically, a position measuring system according to the present invention includes:

a position measuring device mounted on an object to be measured;

an optical fiber installed in a movement area of the object to be measured; and

a light source configured to cause light having at least two wavelengths to be incident on the optical fiber, the position measuring system being characterized in that

the position measuring device includes

a light receiving unit configured to receive scattered light emitted from a side surface of the optical fiber,

a database configured to store a correspondence between information on the scattered light and a position of the object to be measured, and

a determination unit configured to determine, based on the correspondence stored in the database, a position of the object to be measured from information on the scattered light received by the light receiving unit.

Further, a position measuring device according to the present invention is a position measuring device mounted on an object to be measured, the position measuring device being characterized by including:

a light receiving unit configured to receive scattered light emitted from a side surface of an optical fiber installed in a movement area of the object to be measured, the optical fiber being subject to incidence of light having at least two wavelengths;

a database configured to store a correspondence between information on the scattered light and a position of the object to be measured; and

a determination unit configured to determine, based on the correspondence stored in the database, a position of the object to be measured from information on the scattered light received by the light receiving unit.

Still further, a method for measuring a position according to the present invention is characterized by including:

installing an optical fiber in a movement area of an object to be measured;

causing light having at least two wavelengths to be incident on the optical fiber;

receiving scattered light emitted from a side surface of the optical fiber; and

determining, based on a correspondence between information on the scattered light and a position of the object to be measured, a position of the object to be measured from information on the scattered light received.

The position measuring system of the present invention measures light intensity of scattered light emitted from the side surface of the optical fiber, thus allowing the measurement of the position of a portion to be measured even in a place where it is difficult to perform GPS measurement. The position measuring system of the present invention measures scattered light emitted from the side surface of the optical fiber and hence, it is possible to perform distance measurement in plane irrespective of the presence or absence of a blocking object between the light source and an object to be measured. Further, the position measuring system of the present invention uses a plurality of wavelengths and makes use of a difference in attenuation amount between the respective wavelengths and hence, it is possible to measure the position of an object to be measured that moves two-dimensionally.

Accordingly, the present invention can provide a position measuring system, a position measuring device, and a method for measuring a position that can accurately measure the position of an object to be measured without being limited by an environment or an optical axis.

The position measuring system of the present invention may be configured such that the light source is connected to one end of the optical fiber, and the position measuring system further includes a terminator connected to the other end of the optical fiber. In this case, it is preferable that the light source be formed of one wavelength variable light source that performs wavelength switching in a predetermined cycle, and the position measuring device further have a function of detecting the wavelength switching of the light source.

Further, the position measuring system of the present invention may be configured such that one of the light sources is connected to one end of the optical fiber, and the other light source is connected to the other end of the optical fiber, the other light source outputting light having wavelength different from wavelength of light outputted from the one of the light sources.

In the position measuring system of the present invention, the information on the scattered light may be light intensity at each wavelength. Further, in the position measuring system of the present invention, the information on the scattered light may be color information.

The above-mentioned respective inventions may be combined as practically as possible.

### Effects of the Invention

The present invention can provide a position measuring system, a position measuring device, and a method for measuring a position that can accurately measure the position of an object to be measured without being limited by an environment or an optical axis.

### BRIEF DESCRIPTION OF DRAWINGS

FIG. 1 is a view for describing a task of the present invention.

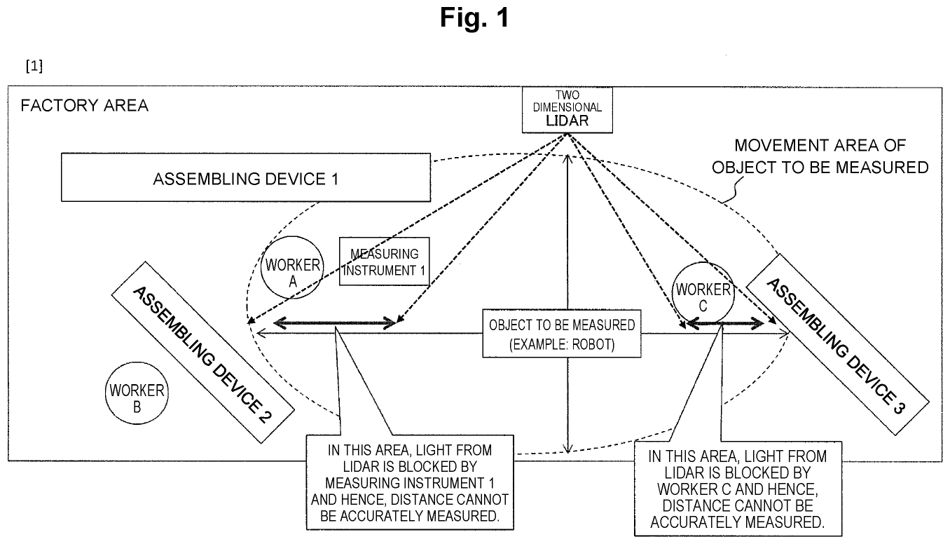

FIG. 2 is a view for describing a position measuring system according to the present invention.

FIG. 3 is a view for describing a position measuring device according to the present invention.

FIG. 4 is a view for describing the measurement principle of the position measuring system according to the present invention.

FIG. 5 is a view for describing a database in the position measuring device according to the present invention.

FIG. 6 is a view for describing a position measuring system according to the present invention.

FIG. 7 is a view for describing a position measuring device according to the present invention.

FIG. 8 is a view for describing a database in the position measuring device according to the present invention.

FIG. 9 is a view for describing a position measuring system according to the present invention.

FIG. 10 is a view for describing the measurement principle of the position measuring system according to the present invention.

FIG. 11 is a view for describing a database in a position measuring device according to the present invention.

FIG. 12 is a view for describing the measurement principle of a position measuring system according to the present invention.

FIG. 13 is a view for describing a database in a position measuring device according to the present invention.

FIG. 14 is a view for describing a position measuring system according to the present invention.

FIG. 15 is a view for describing a position measuring device according to the present invention.

FIG. 16 is a view for describing a method for measuring a position according to the present invention.

### DESCRIPTION OF EMBODIMENTS

Embodiments of the present invention will be described with reference to attached drawings. The embodiments described hereinafter merely form examples of the present invention, and the present invention is not limited to the following embodiments. In this specification and drawings, constitutional elements given the same reference symbols are identical to each other.

### Embodiment 1

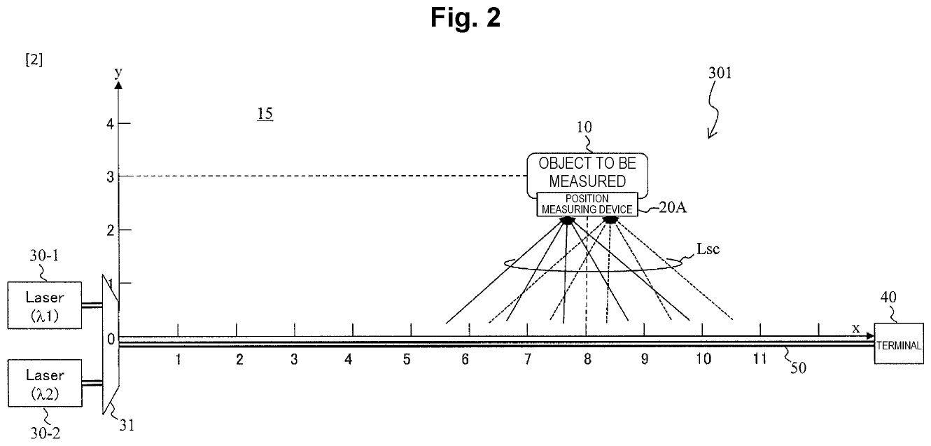

FIG. 2 is a view for describing a position measuring system 301 of this embodiment. The position measuring system 301 includes

a position measuring device 20A mounted on an object to be measured 10,

an optical fiber 50 installed in a movement area 15 of the object to be measured 10, and

a light source 30 configured to cause light having at least two wavelengths to be incident on the optical fiber 50.

In this embodiment, the light source 30 is connected to one end of the optical fiber 50. Specifically, the light source 30 includes a laser 30-1, a laser 30-2, and an optical multiplexer 31. The laser 30-1 outputs light having wavelength λ1. The laser 30-2 outputs light having wavelength λ2. The optical multiplexer 31 multiplexes light outputted from the laser 30-1 and light outputted from the laser 30-2, and causes the light to be incident on one end of the optical fiber 50. In this embodiment, light having two wavelengths is caused to be incident on the optical fiber 50. However, light having three or more wavelengths may be caused to be incident on the optical fiber 50.

The position measuring system 301 further includes a terminator 40 connected to the other end of the optical fiber 50.

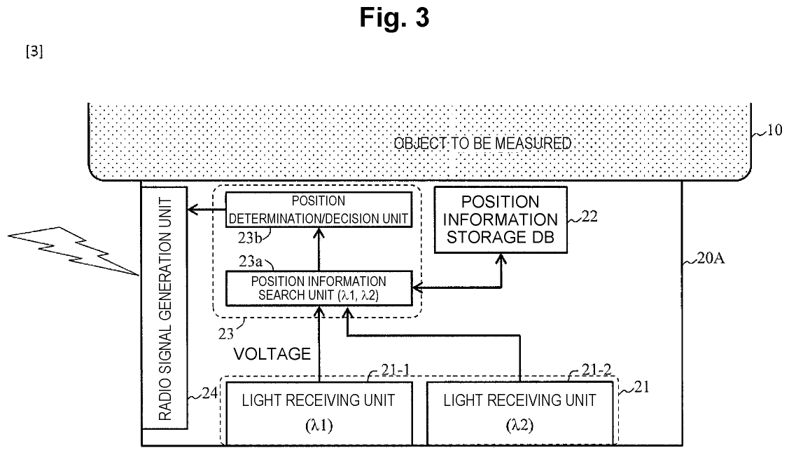

FIG. 3 is a view for describing the configuration of the position measuring device 20A.

The position measuring device 20A is characterized by including

a light receiving unit 21 configured to receive scattered light Lsc emitted from the side surface of the optical fiber 50,

a database 22 configured to store a correspondence between information on the scattered light and the position of the object to be measured, and

a determination unit 23 configured to determine, based on the correspondence stored in the database 22, the position of the object to be measured 10 from information on the scattered light received by the light receiving unit 21.

It is sufficient that the light receiving unit 21 can convert the light intensity of received light to a voltage value. For example, the light receiving unit 21 may be formed of a PD (photo diode).

In this embodiment, light caused to be incident on the optical fiber 50 has two wavelengths, that is, λ1 and λ2. Therefore, the light receiving unit 21 is formed of the light receiving unit 21-1, which can receive light having wavelength λ1 and the light receiving unit 21-2, which can receive light having wavelength λ2. However, in the case where a light receivable range includes the wavelength λ1 and the wavelength λ2, one light receiving unit may be used.

This embodiment is characterized in that the information on the scattered light Lsc is light intensity of each wavelength.

The position measuring system 301 estimates the position of the object to be measured 10 from a voltage value at the time of the scattered light Lsc being received.

In the position measuring system 301, light (continuous light or pulse light) having two wavelengths from two light sources (30-1, 30-2) is multiplexed by the optical multiplexer 31, and is caused to be incident on one end of the optical fiber 50. The terminator 40 is provided at the other end of the optical fiber 50. The optical fiber 50 is an optical fiber that emits light (scattered light) from the side surface thereof in the manner of an LDF (light defusing fiber), for example. Therefore, light caused to be incident on the optical fiber 50 leaks to the outside of the optical fiber 50 as scattered light having light intensity corresponding to a distance from the one end. The position measuring device 20A estimates the position of the object to be measured 10 from light intensity (voltage value) at the time of the scattered light being received.

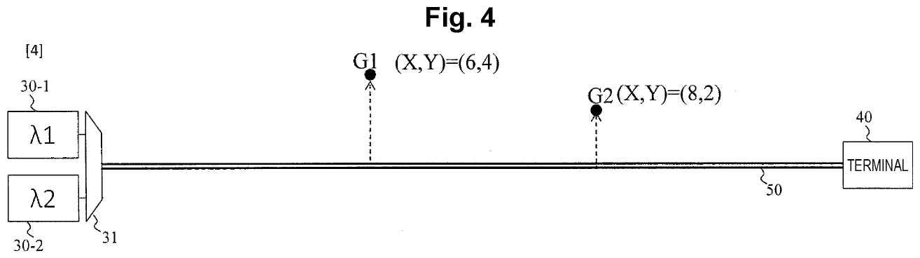

FIG. 4 is a view for describing the measurement principle of the position measuring system 301. The position measuring system 301 makes use of the characteristic of the optical fiber where a propagation loss varies depending on wavelength.

Output power of the laser 30-1 is taken as “P1”, and output power of the laser 30-2 is taken as “P2”. A propagation loss of light having wavelength λ1 per unit length in the optical fiber 50 is taken as “α”, and a propagation loss of light having wavelength λ1 per unit length in a space is taken as “γ”. A propagation loss of light having wavelength λ2 per unit length in the optical fiber 50 is taken as “β”, and a propagation loss of light having wavelength λ2 per unit length in the space is taken as “γ”.

In this case, the light intensity of light having wavelength λ1 and the light intensity of light having wavelength λ2 at a position G1 with coordinates (X, Y)=(6, 4) can be calculated as follows.

(Light intensity of light having wavelength λ1, light intensity of light having wavelength λ2)=(P1−6α−4γ, P2−6β−4γ)

The light intensity of light having wavelength λ1 and the light intensity of light having wavelength λ2 at a position G1 with coordinates (X, Y)=(8, 2) can be calculated as follows.

(Intensity of light having wavelength λ1, intensity of light having wavelength λ2)=(P1−8α−2γ, P2−8β−2γ)

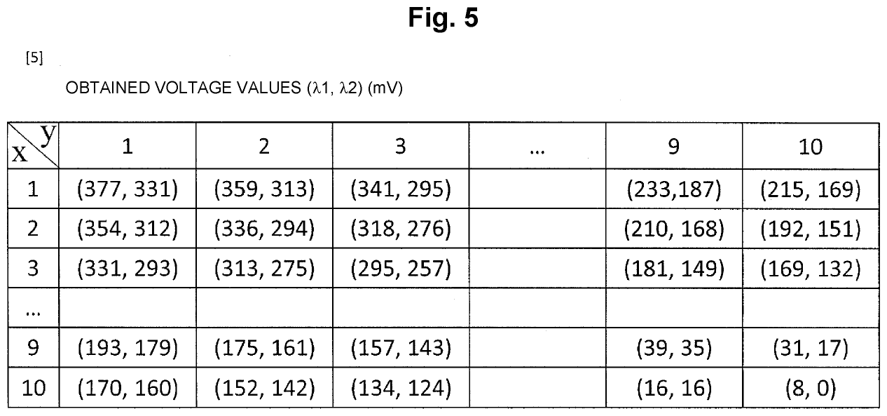

For each position in the movement area 15 of the object to be measured 10, the light intensity of light having wavelength λ1 and the light intensity of light having wavelength λ2 are calculated as described above, are converted to voltage values at the time of light being received by the light receiving unit 21, and are kept in the position information storage database 22. Alternatively, for each position in the movement area 15 of the object to be measured 10, values obtained by actually measuring the light intensity (voltage value) of light having wavelength λ1 and the light intensity (voltage value) of light having wavelength λ2 may be kept in advance in the position information storage database 22. FIG. 5 is a view for describing an example of a correspondence between coordinates and light intensities (voltage values), which is kept in the position information storage database 22.

The position measuring device 20A receives the scattered light Lsc from the optical fiber 50 with the light receiving unit 21 at an arbitrary point of time, and compares the light intensity (voltage value) of light having wavelength λ1 and the light intensity (voltage value) of light having wavelength λ2 with the correspondence kept in the position information storage database 22 to estimate the position of the object to be measured 10.

Specifically, the light receiving unit 21 converts the light intensities of received light to voltage values. A position information search unit 23a collates the voltage values with values in the correspondence held in advance in the position information storage DB 22. Then, a position determination/decision unit 23b estimates that the object to be measured 10 is present at a position where the voltage values match the values in the correspondence. In the case where the voltage values do not match values in the correspondence held in the position information storage DB 22, the position determination/decision unit 23b estimates that the position of values in the correspondence closest to the voltage values is the position of the object to be measured 10 at that time. A radio signal generation unit 24 transmits information on the determined position to an external measurer.

The description has been made with reference to FIG. 3 for the case where the position measuring device 20A includes the light receiving unit that receives light having wavelength λ1 and the light receiving unit that receives light having wavelength λ2. The position measuring system 301 may have another configuration where the position measuring device 20A includes one light receiving unit that can detect both wavelength λ1 and wavelength λ2, light is outputted from the light source 30 in a state where the wavelength of the light is time divided, and the light intensity of light having wavelength λ1 and the light intensity of light having wavelength λ2 are detected for each time period.

The position measuring system 301 can detect, by a simple method, the position of the object to be measured 10 having the degree of freedom in movement in two dimensions.

### Embodiment 2

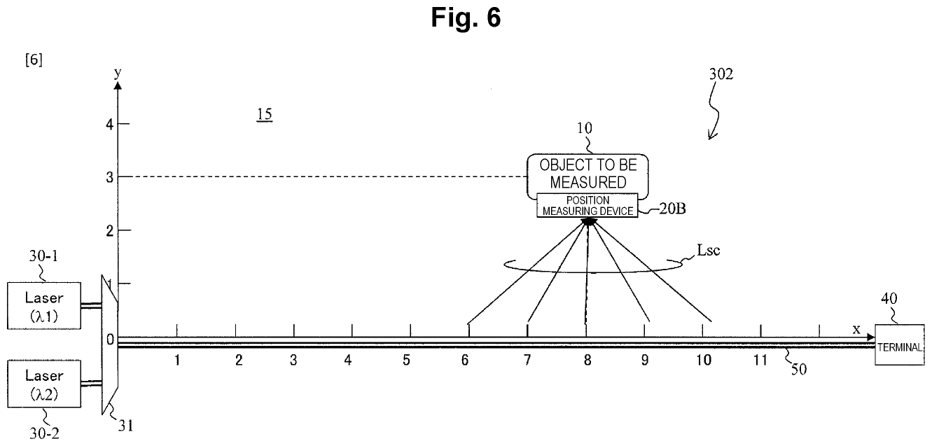

FIG. 6 is a view for describing a position measuring system 302 of this embodiment. The position measuring system 302 differs from the position measuring system 301 shown in FIG. 2 with respect to a point that the position measuring system 302 includes a position measuring device 20B in place of the position measuring device 20A. Hereinafter, the description will be made only with respect to points which make the position measuring system 302 different from the position measuring system 301.

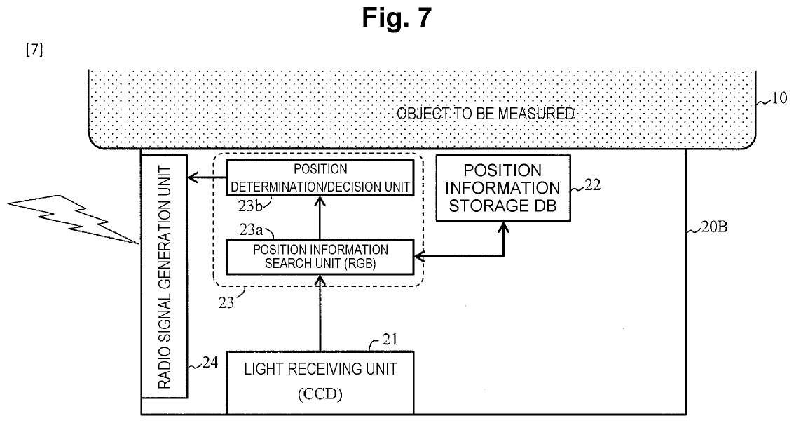

FIG. 7 is a view for describing the configuration of the position measuring device 20B.

The position measuring device 20B is characterized by including

the light receiving unit 21 configured to receive the scattered light Lsc emitted from the side surface of the optical fiber 50,

the database 22 configured to store a correspondence between information on the scattered light and the position of the object to be measured, and

the determination unit 23 configured to determine, based on the correspondence stored in the database 22, the position of the object to be measured 10 from information on the scattered light received by the light receiving unit 21.

This embodiment is characterized in that the information on the scattered light Lsc is color information (RGB).

It is sufficient that the light receiving unit 21 can convert received light to RGB values. For example, the light receiving unit 21 may be formed of a CCD (charge-coupled device) image sensor. The position measuring system 302 converts the scattered light Lsc received by the light receiving unit 21 to RGB values, and estimates the position of the object to be measured 10 from such values.

The measurement principle of the position measuring system 302 is equivalent to the measurement principle described with reference to FIG. 4. As described with reference to FIG. 4, based on a loss of each color per unit length in the optical fiber 50 and a propagation loss of each color per unit length in a space, it is possible to calculate RGB values at each position in the movement area 15 of the object to be measured 10.

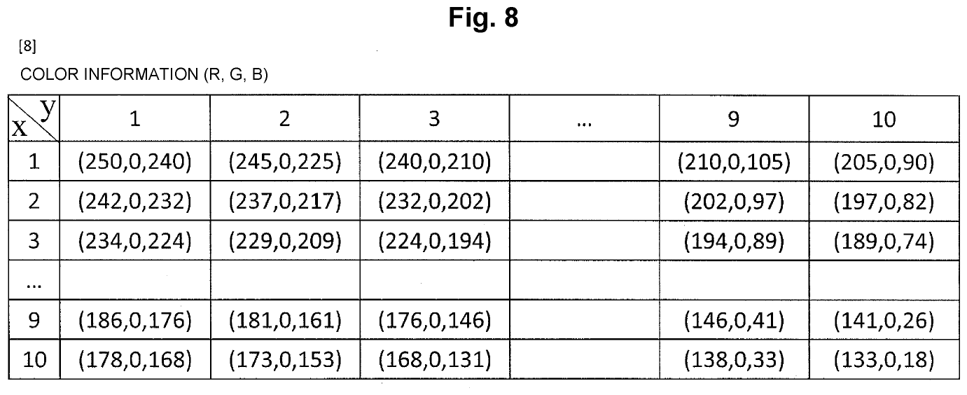

For each position in the movement area 15 of the object to be measured 10, RGB values are calculated as described above, and are kept in the position information storage database 22. Alternatively, for each position in the movement area 15 of the object to be measured 10, values obtained by actually measuring RGB may be kept in advance in the position information storage database 22. FIG. 8 is a view for describing an example of a correspondence between coordinates and RGB values, which is kept in the position information storage database 22.

The position measuring device 20B receives the scattered light Lsc from the optical fiber 50 with the light receiving unit 21 at an arbitrary point of time, and compares the RGB values of the scattered light Lsc with the correspondence kept in the position information storage database 22 to estimate the position of the object to be measured 10.

Specifically, the light receiving unit 21 converts the light intensities of received light to RGB values. The position information search unit 23a collates the RGB values with values in the correspondence held in advance in the position information storage DB 22. Then, the position determination/decision unit 23b estimates that the object to be measured 10 is present at a position where the RGB values match the values in the correspondence. In the case where the RGB values do not match values in the correspondence held in the position information storage DB 22, the position determination/estimation unit 23b estimates that the position of values in the correspondence closest to the RGB values is the position of the object to be measured 10 at that time. The radio signal generation unit 24 transmits information on the determined position to an external measurer.

The position measuring system 302 can detect, by a simple method, the position of the object to be measured 10 having the degree of freedom in movement in two dimensions.

### Embodiment 3

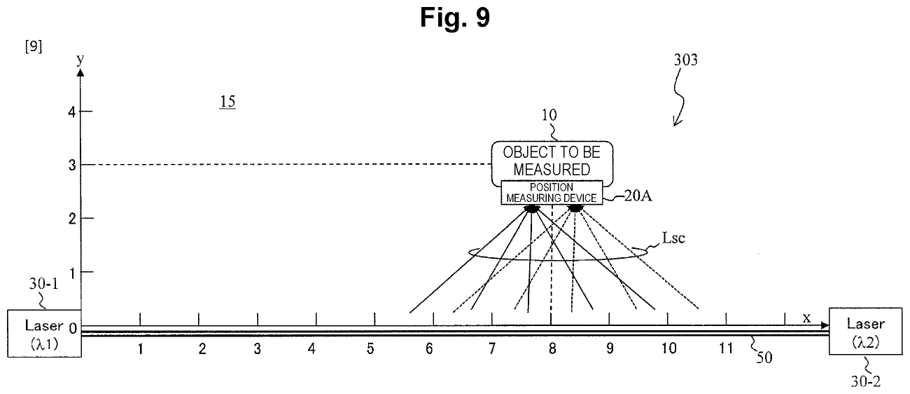

FIG. 9 is a view for describing a position measuring system 303 of this embodiment. The position measuring system 303 differs from the position measuring system 301 shown in FIG. 2 with respect to a point that the laser 30-1 for wavelength λ1 is connected to one end of the optical fiber 50 and the laser 30-2 for wavelength λ2 is connected to the other end of the optical fiber 50. The position measuring system 303 also estimates the position of the object to be measured 10 from voltage values at the time of the scattered light Lsc being received.

In the position measuring system 303, light (continuous light or pulse light) from two light sources (30-1, 30-2) having two wavelengths is respectively caused to be incident on different ends of the optical fiber 50. The position of an object to be measured is estimated from the obtained voltage values of scattered light. Light caused to be incident on the optical fiber 50 leaks to the outside of the optical fiber 50 as scattered light having light intensity corresponding to a distance from one end. The position measuring device 20A estimates the position of the object to be measured 10 from light intensity (voltage value) at the time of the scattered light being received.

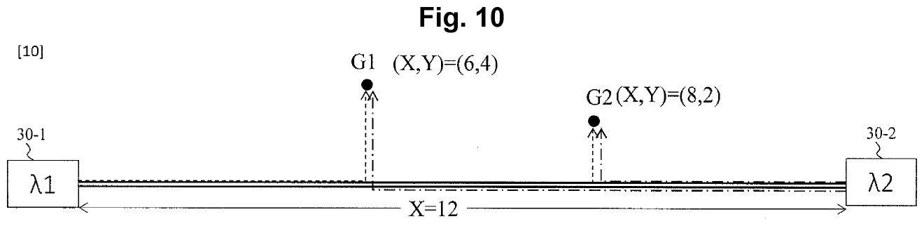

FIG. 10 is a view for describing the measurement principle of the position measuring system 303. The position measuring system 303 makes use of the fact that a propagation loss in the optical fiber 50 differs depending on wavelength.

Output power of the laser 30-1 is taken as “P1”, and output power of the laser 30-2 is taken as “P2”. A propagation loss of light having wavelength λ1 in the optical fiber 50 is taken as “α”, and a propagation loss of light having wavelength λ1 in a space is taken as “γ”. A propagation loss of light having wavelength λ2 in the optical fiber 50 is taken as “β”, and a propagation loss of light having wavelength λ2 in the space is taken as “γ”.

In this case, the light intensity of light having wavelength λ1 and the light intensity of light having wavelength λ2 at a position G1 with coordinates (X, Y)=(6, 4) can be calculated as follows:

(Light intensity of light having wavelength γ1, light intensity of light having wavelength λ2)=(P1−6α−4γ, P2−6β−4γ)

The light intensity of light having wavelength λ1 and the light intensity of light having wavelength λ2 at a position G1 with coordinates (X, Y)=(8, 2) can be calculated as follows:

(Light intensity of light having wavelength λ1, light intensity of light having wavelength λ2)=(P1−8α−2γ, P2−4β−2γ)

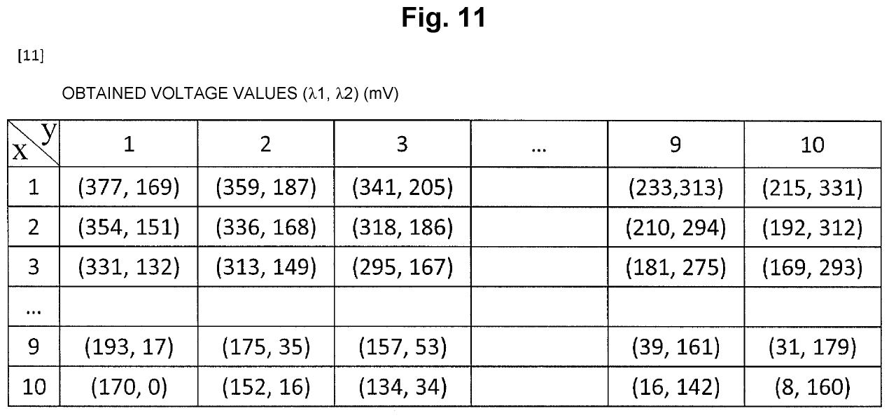

For each position in the movement area 15 of the object to be measured 10, the light intensity of light having wavelength λ1 and the light intensity of light having wavelength λ2 are calculated as described above, are converted to voltage values at the time of light being received by the light receiving unit 21, and are kept in the position information storage database 22. Alternatively, for each position in the movement area 15 of the object to be measured 10, values obtained by actually measuring the light intensity (voltage value) of light having wavelength λ1 and the light intensity (voltage value) of light having wavelength λ2 may be kept in advance in the position information storage database 22. FIG. 11 is a view for describing an example of a correspondence between coordinates and light intensities (voltage values), which is kept in the position information storage database 22.

A method for estimating the position of the object to be measured 10 by the position measuring device 20A is substantially equivalent to the method described with respect to the position measuring system 301 of the embodiment 1. Accordingly, the position measuring system 303 can also detect, by a simple method, the position of the object to be measured 10 having the degree of freedom in movement in two dimensions.

### Embodiment 4

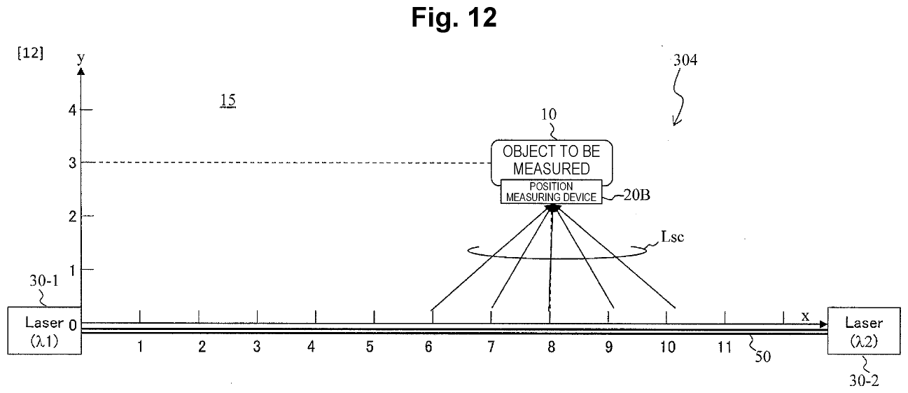

FIG. 12 is a view for describing a position measuring system 304 of this embodiment. The position measuring system 304 differs from the position measuring system 303 shown in FIG. 9 with respect to a point that the position measuring system 304 includes the position measuring device 20B in place of the position measuring device 20A. That is, in the position measuring system 304, a CCD camera is used as the light receiving unit 21, received scattered light Lsc is converted to RGB values, and the position of the object to be measured 10 is estimated from such values.

The measurement principle of the position measuring system 304 is equivalent to the measurement principle described with reference to FIG. 10. As described with reference to FIG. 10, based on a loss of each color per unit length in the optical fiber 50 and a propagation loss of each color per unit length in a space, it is possible to calculate RGB values at each position in the movement area 15 of the object to be measured 10.

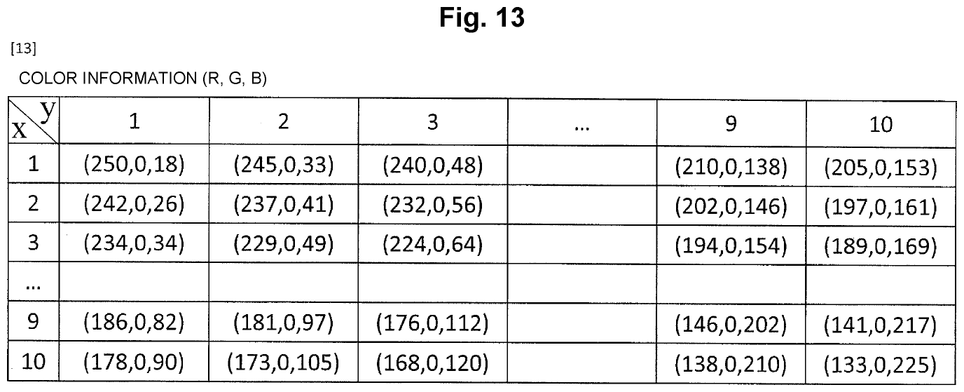

For each position in the movement area 15 of the object to be measured 10, RGB values are calculated as described above, and are kept in the position information storage database 22. Alternatively, for each position in the movement area 15 of the object to be measured 10, values obtained by actually measuring RGB may be kept in advance in the position information storage database 22. FIG. 13 is a view for describing an example of a correspondence between coordinates and RGB values, which is kept in the position information storage database 22.

A method for estimating the position of the object to be measured 10 by the position measuring device 20B is equivalent to the method described with respect to the position measuring system 302 of the embodiment 2. Accordingly, the position measuring system 304 can also detect, by a simple method, the position of the object to be measured 10 having the degree of freedom in movement in two dimensions.

### Embodiment 5

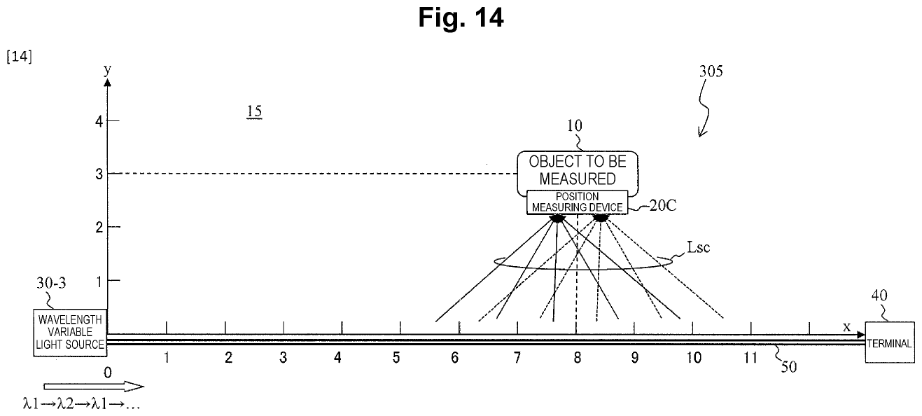

FIG. 14 is a view for describing a position measuring system 305 of this embodiment. The position measuring system 305 differs from the position measuring system 301 shown in FIG. 2 with respect to a point that the position measuring system 305 includes one light source. Specifically, the light source of the position measuring system 305 is formed of one wavelength variable light source 30-3 that performs wavelength switching in a predetermined cycle. The cycle of performing wavelength switching is set to a cycle sufficiently short relative to the movement speed of the object to be measured 10. For example, in the case where a movement speed v of the object to be measured 10 is 5 m/sec and it is desired to set position measurement accuracy Ac to 0.1 m or less, a switching cycle is set to a value that satisfies Ac/v=0.02 sec or less.

In this embodiment, light having two wavelengths is caused to be incident on the optical fiber 50. However, light having three or more wavelengths may be caused to be incident on the optical fiber 50.

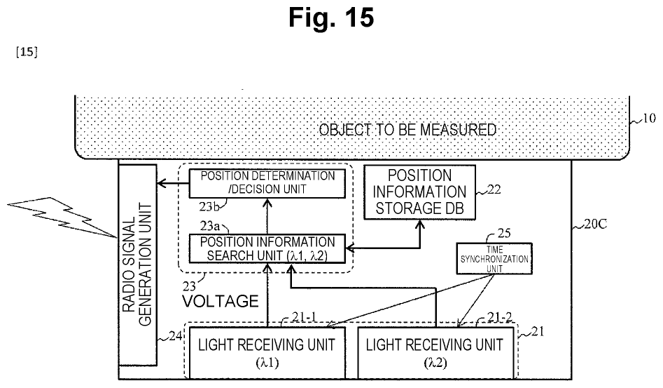

FIG. 15 is a view for describing the configuration of a position measuring device 20C of the position measuring system 305.

The position measuring device 20C differs from the position measuring device 20A shown in FIG. 3 with respect to a point that the position measuring device 20C further has a function of detecting wavelength switching of the wavelength variable light source 30-3. The function of detecting wavelength switching is achieved by a time synchronization unit 25. In synchronization with wavelength switching of the wavelength variable light source 30-3, the time synchronization unit 25 switches between a light receiver 21-1 and a light receiver 21-2 to switch wavelength to be measured. It is desirable that the timing of wavelength switching performed by the time synchronization unit 25 be synchronized, by wireless communication, with the timing of wavelength switching performed by the wavelength variable light source 30-3.

Based on information from the time synchronization unit 25, the light receiving unit 21-1 acts to receive light having wavelength λ1 outputted from the wavelength variable light source 30-3, and the light receiving unit 21-2 acts to receive light having wavelength λ2 outputted from the wavelength variable light source 30-3. Each of the light receiving units (21-1, 21-2) converts the light intensity of received light to a voltage value. As described in the embodiment 1, the determination unit 23 collates the voltage values with the correspondence shown in FIG. 5 and held in advance in the position information storage DB 22, and determines that the object to be measured 10 is present at a position with coordinates which match the voltage values. Further, in the case where voltage values held in the position information storage DB 22 do not match obtained voltage values as a result of collation, the position determination/estimation unit 23b estimates the position of the object to be measured 10 as described in the embodiment 1. The radio signal generation unit 24 transmits data of information on the position of the object to be measured 10 to an external measurer.

### ANOTHER EXAMPLE 1

A configuration may be adopted where a light receiving unit is not provided for each wavelength, so that a single light receiving unit receives light at all wavelengths and wavelength of light is specified for each time slot based on information from the time synchronization unit 25.

### ANOTHER EXAMPLE 2

As described in the embodiment 2, the position measuring device 20C may include the light receiving unit 21 formed of a CCD image sensor. A configuration may be adopted where the light receiving unit 21 obtains RGB values rather than voltage values, collates the RGB values with the correspondence shown in FIG. 8 and held in advance in the position information storage DB 22, and determines that the object to be measured 10 is present.

### ANOTHER EXAMPLE 3

The function of detecting wavelength switching may not be achieved by the time synchronization unit 25, but may be achieved by the following configuration: the wavelength variable light source 30-3 delivers light in a state where the light is modulated at a frequency which differs for each wavelength, and the position measuring device 20C is caused to have a function of detecting the frequency. Therefore, it is possible to determine what wavelength the received light has. This configuration can determine wavelength without requiring time synchronization.

### Embodiment 6

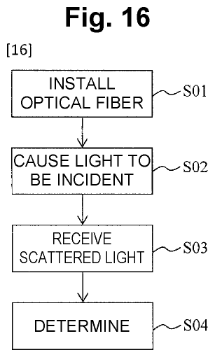

FIG. 16 is a flowchart for describing an operation of performing position measurement by the position measuring system (301 to 304).

A method for performing the operation includes:

installing the optical fiber 50 in the movement area 15 of the object to be measured 10 (step S01);

causing light having at least two wavelengths to be incident on the optical fiber 50 (step S02);

receiving the scattered light Lsc emitted from the side surface of the optical fiber 50 (step S03); and

determining, based on a correspondence between information on the scattered light Lsc and the position of the object to be measured 10, the position of the object to be measured 10 from the information on the scattered light Lsc received (step S04).

### Another Embodiment

The position measuring device (20, 20a) of the present invention can also be achieved by a computer and a program. The program can be recorded in a recording medium or can be provided through a network.

### REFERENCE SIGNS LIST

10 Object to be measured
15 Movement area
20A, 20B, 20C Position measuring device
21, 21-1, 21-2 Light receiving unit
22 Database
23 Determination unit
23a Position information search unit
23b Position determination/decision unit
24 Radio signal generation unit
25 Time synchronization unit
30, 30-1, 30-2 Light source
31 Optical multiplexer
40 Terminator
50 Optical fiber
301 to 305 Position measuring system

1. A position measuring system comprising:
a position measuring device mounted on an object to be measured;
an optical fiber installed in a movement area of the object to be measured; and
a light source configured to cause light having at least two wavelengths to be incident on the optical fiber, wherein
the position measuring device includes
a light receiving unit configured to receive scattered light emitted from a side surface of the optical fiber,
a database configured to store a correspondence between information on the scattered light and a position of the object to be measured, and
a determination unit configured to determine, based on the correspondence stored in the database, a position of the object to be measured from information on the scattered light received by the light receiving unit.

2. The position measuring system according to claim 1, wherein
the light source is connected to one end of the optical fiber, and
the position measuring system further comprises a terminator connected to the other end of the optical fiber.

3. The position measuring system according to claim 2, wherein
the light source is formed of one wavelength variable light source that performs wavelength switching in a predetermined cycle, and
the position measuring device further has a function of detecting the wavelength switching of the light source.

4. The position measuring system according to claim 1, wherein
one of the light sources is connected to one end of the optical fiber, and another of the light sources is connected to the other end of the optical fiber, the another of the light sources outputting light having wavelength different from wavelength of light outputted from the one of the light sources.

5. The position measuring system according to claim 1, wherein the information on the scattered light is light intensity at each wavelength.

6. The position measuring system according to claim 1, wherein the information on the scattered light is color information.

7. A position measuring device mounted on an object to be measured, the position measuring device comprising:
a light receiving unit configured to receive scattered light emitted from a side surface of an optical fiber installed in a movement area of the object to be measured, the optical fiber being subject to incidence of light having at least two wavelengths;
a database configured to store a correspondence between information on the scattered light and a position of the object to be measured; and
a determination unit configured to determine, based on the correspondence stored in the database, a position of the object to be measured from information on the scattered light received by the light receiving unit.

8. A method for measuring a position, the method comprising:
installing an optical fiber in a movement area of an object to be measured;
causing light having at least two wavelengths to be incident on the optical fiber;
receiving scattered light emitted from a side surface of the optical fiber; and
determining, based on a correspondence between information on the scattered light and a position of the object to be measured, a position of the object to be measured from information on the scattered light received.
